(19) United States
(12) Patent Application Publication
(10) Pub. No.: US 2026/0341731 A1
(43) Pub. Date: Oct. 29, 2026

(54) NEGATIVE ELECTRODE FOR LITHIUM SECONDARY BATTERY AND LITHIUM SECONDARY BATTERY INCLUDING THE SAME

(71) Applicants: LG Energy Solution, Ltd., Seoul (KR); KOREA ADVANCED INSTITUTE OF SCIENCE AND TECHNOLOGY, Daejeon (KR)

(72) Inventors: Il-Doo Kim, Daejeon (KR); Hyunsub Song, Daejeon (KR); Jiyoung Lee, Gyeonggi-do (KR); Seung-Hun Lee, Daejeon (KR); Chang-Hoon Lee, Daejeon (KR); Mingyu Sagong, Daejeon (KR); Jiwon Jeon, Seoul (KR)

(21) Appl. No.: 19/578,417

(22) Filed: Mar. 25, 2026

(30) Foreign Application Priority Data
Apr. 23, 2025 (KR) 10-2025-0053252
Feb. 11, 2026 (KR) 10-2026-0027808

(51) Int. Cl. H01M 4/62; H01M 4/02; H01M 4/36; H01M 4/38; H01M 10/0525

(52) U.S. Cl. CPC H01M 4/628; H01M 4/366; H01M 4/382; H01M 10/0525; H01M 2004/027

(57) ABSTRACT

The present disclosure provides a negative electrode for a lithium secondary battery using a lithium metal as a negative electrode active material, wherein the negative electrode has a protective layer that is effective in minimizing side reactions at an interface between the lithium metal negative electrode and an electrolyte, and suppressing the formation of lithium dendrites on the lithium metal and a lithium secondary battery including the same.

### TECHNICAL FIELD

The present disclosure relates to a negative electrode for use in a lithium secondary battery. More particularly, the present disclosure relates to a lithium metal negative electrode using a lithium metal as a negative electrode active material.

This application is based on and claims priority from Korean Patent Application No. 2025-0053252 filed on Apr. 23, 2025 and Korean Patent Application No. 2026-0027808 filed on Feb. 11, 2026 with the Korean Intellectual Property Office, the disclosure of which is incorporated herein in its entirety by reference.

### BACKGROUND ART

Lithium-ion batteries primarily use conductive carbon materials such as graphite as active materials, and are used in a wide range of applications including small electronic devices such as smartphones, laptop computers or electrical appliances and large-scale electronic devices such as electric vehicles. In these circumstances, there is a rapidly increasing need for technology development of next-generation secondary batteries with higher performance and longer lifespan.

Lithium metal secondary batteries considered as next-generation batteries are attracting attention in the field of advanced electronic devices that require lighter weight and smaller size due to the outstanding characteristics of lithium metal electrode such as high theoretical capacity of 3860 mAh/g, low density of 0.59 g/cm³ and low standard electrode potential, contributing to high energy density and high output characteristics, compared to lithium-ion batteries. The lithium metal secondary batteries using lithium metal as negative electrode may be largely classified into liquid electrolyte-based lithium-sulfur batteries, lithium-air batteries and solid electrolyte-based all-solid-state batteries according to the state of the electrolyte. The lithium-sulfur batteries and the lithium-air batteries provide high energy density, and the all-solid-state batteries provide improved safety.

However, the common technical factor that hinders commercialization of lithium metal secondary batteries is high reactivity of lithium, causing uneven movement of lithium ions from lithium metal electrode during continued charging and discharging. Furthermore, a solid-electrolyte interphase layer is formed on the surface of lithium metal electrode due to side reactions between lithium metal electrode and electrolyte, and it accelerates the formation of lithium dendrites and restricts lithium movement, creating “dead lithium” where the electrode cannot play its role. This phenomenon is the major factor that hinders the role and stability of active materials and reduces the life of secondary batteries.

To address these issues, attempts have been made to add artificial protective films made of polymers, metal oxides or organic/inorganic composite compounds to the surface of the lithium metal. In particular, to do this, lithium ion conductivity, even distribution and rapid diffusion of ions and dendrite inhibition are the essential functions required for the artificial protective film, but meeting these requirements is challenging.

### DISCLOSURE

### Technical Problem

To address the above-described issues, the present disclosure is directed to providing a negative electrode having a protective layer. Specifically, an aspect of the present disclosure is directed to providing a lithium metal negative electrode having an artificial protective film and a lithium metal battery comprising the same.

For example, the present disclosure is directed to providing the negative electrode having the protective layer for overcoming chemical and mechanical instability of the lithium metal negative electrode.

Specifically, according to an aspect of the present disclosure, the present disclosure is directed to providing the negative electrode having a porous fiber film including hollow nanofibers formed through electrospinning as the protective layer on the surface of the lithium metal negative electrode. For example, the present disclosure is directed to providing the negative electrode having the protective layer for suppressing the growth of dendrites on the negative electrode by even distribution and diffusion of lithium ions through a hollow structure within the porous fiber film.

Furthermore, according to an aspect of the present disclosure, the present disclosure is directed to providing a negative electrode with improved stability by a sustainable and eco-friendly method and a lithium secondary battery comprising the same.

Through this, according to an aspect of the present disclosure, the present disclosure is directed to improving the life of the lithium secondary battery comprising the negative electrode including a lithium metal layer.

### Technical Solution

To achieve the above-described objectives,
according to an aspect of the present disclosure, provided is a negative electrode for a lithium secondary battery of the following embodiments.

The negative electrode according to a first embodiment comprises:
a lithium metal layer; and
a porous fiber film that contacts at least one surface of the lithium metal layer,
wherein the porous fiber film comprises a main polymer and a carrier polymer,
wherein the main polymer contains at least one anionic functional group, and
wherein the carrier polymer contains a functional group that forms a hydrogen bond with the anionic functional group of the main polymer.

According to a second embodiment, in the first embodiment,
the porous fiber film may be manufactured by electrospinning.

According to a third embodiment, in the first or second embodiment,
the porous fiber film may include hollow nanofibers.

According to a fourth embodiment, in any one of the first to third embodiments,
a diameter of the hollow nanofiber may be 50 nm to 3 μm.

According to a fifth embodiment, in any one of the first to fourth embodiments,
a diameter of a void inside the hollow nanofiber may be 10 nm to 1 μm.

According to a sixth embodiment, in any one of the first to fifth embodiments,
a thickness of the porous fiber film may be 100 nm to 100 μm.

According to a seventh embodiment, in any one of the first to sixth embodiments,
the anionic functional group may include a carboxylate group, a sulfonate group, a sulfate group, a phosphate group, a phosphonate group, an imide-based anionic group, a phenolate group, or two or more thereof.

According to an eighth embodiment, in any one of the first to seventh embodiments,
the main polymer may include guar gum, carboxymethyl guar gum, cellulose acetate, a copolymer of two or more monomers, or a mixture thereof.

According to a ninth embodiment, in any one of the first to eighth embodiments,
the carrier polymer may include polyvinylidene fluoride, poly(vinylidene fluoride-co-hexafluoropropylene), perfluoropolymer, polyvinyl alcohol, polyvinyl chloride (PVC), polyvinylidene chloride (PVDC), polyethylene oxide, polyethylene glycol dialkyl ether, polyethylene glycol dialkyl ester, poly(oxymethylene-oligo-oxyethylene), polypropylene oxide (PPO), polyvinylacetate, poly(vinylpyrrolidone-vinylacetate), polystyrene (PS), polyacrylonitrile (PAN), polyacrylamide (PAM), polymethyl methacrylate, polyamide, polyimide, poly(meta-phenylene isophthalamide), polysulfone, polyether ketone, polyetherimide, polyethylene terephthalate, polyethylene naphthalate, polyester, poly(1,1,2,2-tetrafluoroethylene), polyphosphazene, polyurethane, a copolymer of two or more monomers, or a mixture thereof.

According to a tenth embodiment, in any one of the first to ninth embodiments,
the carrier polymer may contain an amide group.

According to an eleventh embodiment, in any one of the first to tenth embodiments,
the main polymer may include carboxymethyl guar gum, and
the carrier polymer may include polyacrylamide.

According to a twelfth embodiment, in any one of the first to eleventh embodiments,
a weight ratio of the main polymer to the carrier polymer may be 5:1 to 1:5.

According to a thirteenth embodiment, in any one of the first to twelfth embodiments,
a weight ratio of the main polymer to the carrier polymer may be 2:1 to 1:2.

According to a fourteenth embodiment, in any one of the first to thirteenth embodiments,
a thickness of the lithium metal layer may be 50 nm to 600 μm.

According to another aspect of the present disclosure, provided is a lithium secondary battery of the following embodiments.

The lithium secondary battery according to a fifteenth embodiment may comprise the negative electrode according to any one of the first to fourteenth embodiments, a positive electrode, an electrolyte and a battery case.

### Advantageous Effects

The negative electrode according to an aspect of the present disclosure may avoid the destruction of the protective layer during the charge and discharge cycles of the lithium secondary battery, thereby keeping the surface of the lithium metal layer covered with the protective layer. Through this, according to an aspect of the present disclosure, it may be possible to suppress corrosion reactions of the negative electrode including the lithium metal layer with the electrolyte during the charge and discharge cycles of the electrochemical device, thereby drastically preventing the cell capacity decline over the repeated charge and discharge cycles, leading to significantly improved life of the battery.

According to an aspect of the present disclosure, the porous structure of the porous fiber film as the protective layer of the negative electrode induces even distribution and flow of lithium ions and a composition change of the solid electrolyte interface (SEI), thereby suppressing the formation of lithium dendrites and dead lithium, leading to improved cycle life characteristics of the lithium metal secondary battery. In particular, because the porous fiber film is made of hollow nanofibers, the internal hollow structure may induce even distribution and diffusion of lithium ions, thereby dramatically improving the life.

Furthermore, according to an aspect of the present disclosure, because the porous fiber film has higher mechanical properties (for example, elasticity) than the lithium metal, despite volume changes of the lithium metal over the repeated charge and discharge cycles of the lithium secondary battery, the shape of the lithium metal negative electrode may be stably maintained, leading to further improved stability. For example, the porous fiber film may have improved mechanical properties (for example, elasticity) through hydrogen bonds between the main polymer and the carrier polymer, but the mechanism of the present disclosure is not limited thereto.

In addition, according to an aspect of the present disclosure, because the eco-friendly, naturally decomposable polymer is used as the component of the protective layer, it is possible to provide the sustainable and eco-friendly lithium secondary battery.

### BRIEF DESCRIPTION OF THE DRAWINGS

FIG. 1 is a diagram of a lithium metal electrode having a porous fiber film including hollow nanofibers according to an embodiment of the present disclosure.

FIG. 2 is a diagram showing the structure of a negative electrode for a lithium secondary battery according to an embodiment of the present disclosure.

FIG. 3 is a diagram of a lithium metal secondary battery using a liquid-state electrolyte according to an embodiment of the present disclosure.

FIG. 4 is a diagram of a lithium metal secondary battery using a solid-state electrolyte according to an embodiment of the present disclosure.

FIG. 5 is a Focused Ion Beam-Scanning Electron Microscopy (FIB-SEM) cross-sectional image of a porous fiber film of Example 1 in this specification.

FIG. 6 is a graph showing evaluation results according to Experimental Example 1 in this specification.

FIG. 7 is a graph showing evaluation results according to Experimental Example 2 in this specification.

FIG. 8 is a graph showing evaluation results according to Experimental Example 3 in this specification.

FIG. 9 is an FIB-SEM cross-sectional image of porous fiber films of Example 1 (left) and Comparative Example 2 (right) in lithium symmetric batteries after 50 cycles according to Experimental Example 4 in this specification.

FIG. 10 is an SEM surface image of porous fiber films of Example 1 (left) and Comparative Example 2 (right) in lithium symmetric batteries after 50 cycles according to Experimental Example 4 in this specification.

### BEST MODE

Hereinafter, the present disclosure will be described in further detail.

The words or terms used in the specification and the appended claims should not be construed as limited to general and dictionary meanings, and rather, should be interpreted based on the meanings and concepts corresponding to the technical aspects of the present disclosure on the basis of the principle that the inventor is allowed to define terms appropriately for the best explanation.

The terms as used herein are used to describe embodiments of the present disclosure but not intended to be limiting. The singular forms include the plural forms unless the context clearly indicates otherwise. It should be understood that the terms ‘comprise’, ‘include’ and ‘have’ when used in this specification, specify the presence of the stated feature, figure, step, operation, element, component or a combination thereof, but do not preclude the presence or addition of one or more other features, figures, steps, operations, elements, components or a combination thereof.

In this specification, “A and/or B” refers to either A or B, or both.

Lithium secondary batteries generally have a feature that lithium metal deposits on negative electrode over repeated charge and discharge cycles due to reduction reactions of lithium ions on the negative electrode surface during charging and discharging.

### Negative Electrode for Lithium Secondary Battery

According to an aspect of the present disclosure, provided is a negative electrode in which intercalation and/or deintercalation of lithium ions occurs at a consistent speed on the surface of the negative electrode to suppress the dendrite formation of lithium ions on the surface of the negative electrode, thereby improving the life of a lithium secondary battery using the same.

The negative electrode according to an aspect of the present disclosure includes a lithium metal layer and a porous fiber film that contacts at least one surface of the lithium metal layer.

Specifically, the porous fiber film includes a main polymer and a carrier polymer. The main polymer contains at least one anionic functional group, and the carrier polymer contains a functional group that forms hydrogen bonds with the anionic functional group of the main polymer.

According to an embodiment of the present disclosure, the porous fiber film on at least one surface of the lithium metal layer may provide movement pathways for uniform movement of lithium ions through the porous structure. Specifically, the porous fiber film includes the main polymer containing the anionic functional group to help fast and uniform movement of lithium ions through coordinate bonds of lithium ions with the main polymer, but the mechanism of the present disclosure is not limited thereto. Additionally, in addition to the main polymer, the porous fiber film includes the carrier polymer to support the main polymer to maintain the stable structure of the film including the main polymer. More specifically, to support the main polymer, the porous fiber film may include the carrier polymer containing the functional group that forms hydrogen bonds with the anionic functional group of the main polymer, but the mechanism of the present disclosure is not limited thereto.

In an embodiment of the present disclosure, the main polymer contain the anionic functional group that can coordinate with lithium ions, and may include a biocompatible polymer. When the biocompatible polymer is used as the main polymer, it may have a beneficial effect on eco-friendliness of the lithium secondary battery, but the present disclosure is not limited thereto.

In an embodiment of the present disclosure, the anionic functional group included in the main polymer is not limited to a particular one and may include those that coordinate with lithium ions as described above. For example, the anionic functional group may include a carboxylate group (—COO⁻), a sulfonate group (—SO₃⁻), a sulfate group (—OSO₃⁻), a phosphate group (—PO₄²⁻), a phosphonate group (—PO₃²⁻), an imide-based anionic group (—SO₂—N⁻—SO₂—), a phenolate group (aromatic-O⁻) or two or more of them.

In an embodiment of the present disclosure, the main polymer is not limited to a particular one and may include those that dissolve in an aqueous solvent, and in particular, may include those containing the anionic functional group for increasing the solubility of the main polymer through interactions with the aqueous solvent.

In an embodiment of the present disclosure, the main polymer may contain, for example, a carboxylate group as the anionic functional group.

In an embodiment of the present disclosure, the main polymer may include, for example, guar gum, carboxymethyl guar gum, cellulose acetate, a copolymer of monomers of two or more of them or a mixture thereof, but the present disclosure is not limited thereto.

In an embodiment of the present disclosure, the main polymer may include, for example, guar gum, carboxymethyl guar gum or a mixture thereof, but the present disclosure is not limited thereto.

In an embodiment of the present disclosure, the carrier polymer is not limited to a particular type and may include those that support the main polymer to improve the mechanical strength of the porous fiber film compared to when the porous fiber film includes the main polymer alone. For example, the carrier polymer is not limited to a particular one and may include those containing the functional group that forms hydrogen bonds with the anionic functional group of the main polymer.

In an embodiment of the present disclosure, the carrier polymer may include, for example, polyvinylidene fluoride, poly(vinylidene fluoride-co-hexafluoropropylene), perfluoropolymer, polyvinyl alcohol, polyvinyl chloride, polyvinylidene chloride, polyethylene oxide, polyethylene glycol dialkyl ether, polyethylene glycol dialkyl ester, poly(oxymethylene-oligo-oxyethylene), polypropylene oxide, polyvinylacetate, poly(vinylpyrrolidone-vinylacetate), polystyrene, polyacrylonitrile, polyacrylamide, polymethyl methacrylate, polyamide, polyimide, poly(meta-phenylene isophthalamide), polysulfone, polyether ketone, polyetherimide, polyethylene terephthalate, polyethylene naphthalate, polyester, poly(1,1,2,2-tetrafluoroethylene), polyphosphazene, polyurethane, a copolymer of monomers of two or more of them, or a mixture thereof, but the present disclosure is not limited thereto.

In an embodiment of the present disclosure, the carrier polymer may, for example, contain an amide group. For example, the carrier polymer may contain polyacrylamide (PAM).

In an embodiment of the present disclosure, the main polymer may contain a carboxylate group, and the carrier polymer may contain an amide group. The amide group of the carrier polymer may form hydrogen bonds with the carboxylate group of the main polymer, and when the carrier polymer forms coordinate bonds with lithium ions, the hydrogen bonds between the main polymer and the carrier polymer may be reduced, but the present disclosure is not limited thereto.

In an embodiment of the present disclosure, the main polymer may include carboxymethyl guar gum, and the carrier polymer may include polyacrylamide.

In an embodiment of the present disclosure, the porous fiber film may, for example, have a porosity of 10 vol % or more. Specifically, the porosity of the porous fiber film may, for example, be 50 vol % to 99 vol %, and more specifically 80 vol % to 95 vol %, but the present disclosure is not limited thereto. When the porosity of the porous fiber film falls within the aforementioned range, it may have a beneficial effect in suppressing the formation of lithium dendrites, but the present disclosure is not limited thereto. The porosity of the porous fiber film may, for example, be a measured value using a known mercury intrusion porosimeter (MIP, PM33GT, Quantachrome).

In an embodiment of the present disclosure, the porous fiber film may, for example, be manufactured by electrospinning. When the porous fiber film is manufactured by electrospinning, it may have a beneficial effect in suppressing the formation of lithium dendrites and improving the mechanical strength of the protective layer (the porous fiber film), but the present disclosure is not limited thereto. For example, the porous fiber film may be formed by applying a polymer-containing solution to at least one surface of the lithium metal layer, a separator or a current collector and drying the polymer-containing solution. However, when the porous fiber film is formed as a free-standing film by electrospinning, the porous fiber film may act as a protective layer to suppress the formation of lithium dendrites, as well as improving the mechanical strength, thereby maintaining the shape of the negative electrode despite volume changes of the negative electrode over the repeated charge and discharge cycles of the lithium secondary battery.

In an embodiment of the present disclosure, the porous fiber film may be the free-standing film formed by electrospinning, including the main polymer containing the anionic functional group that coordinates with lithium ions and the carrier polymer containing the functional group that forms hydrogen bonds with the anionic functional group of the main polymer.

According to an embodiment of the present disclosure, after it is formed as the free-standing film, the porous fiber film may be separated from an electrospinning substrate, and transferred to at least one surface of the lithium metal layer, the separator or the current collector such that they are brought into contact with each other, but the present disclosure is not limited thereto.

In an embodiment of the present disclosure, the porous fiber film may be manufactured through electrospinning using the solution containing the main polymer to perform the main role of transporting lithium ions. In this instance, the carrier polymer may play a role in assisting the electrospinning of the main polymer.

In an embodiment of the present disclosure, the electrospinning may be performed by the commonly used electrospinning method using the polymer solution containing the main polymer and the carrier molecule, and is not particularly limited to the electrospinning method.

In an embodiment of the present disclosure, when the porous fiber film is manufactured by electrospinning, as opposed to the conventional process for manufacturing the negative electrode protective layer, the porous fiber film may be manufactured without a combustion process, but the present disclosure is not limited thereto.

In an embodiment of the present disclosure, when the porous fiber film is manufactured by electrospinning, the porous fiber film may be manufactured without any additive other than the solvent, the main polymer and the carrier polymer, and accordingly, the resultant porous fiber film may only include the main polymer and the carrier polymer.

In an embodiment of the present disclosure, the biocompatible polymer may be used as the main polymer, and the electrospinning may be performed in the aqueous solvent, for example, a water (H₂O) system, but the present disclosure is not limited thereto.

According to an embodiment of the present disclosure, the porous fiber film may include hollow nanofibers.

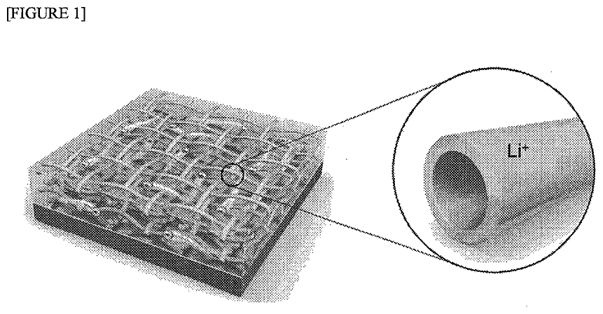

FIG. 1 is a diagram of the porous fiber film according to an embodiment of the present disclosure. Referring to FIG. 1, the porous fiber film may have networks formed by laying nanofibers having internal voids over one another. The voids inside the hollow nanofibers may be formed by interactions between the main polymer and the carrier polymer. For example, the interactions between the anionic functional group of the main polymer and the functional group of the carrier polymer, for example, hydrogen bonds may drive the formation of the nanofibers in which the gap between the two polymers is kept constant, and through this, the voids may be formed within the nanofibers, but the mechanism of the present disclosure is not limited thereto. When the porous fiber film includes the hollow nanofibers, movement of lithium ions situated in the voids may occur, and through this, the formation of lithium dendrites may be suppressed, but the mechanism of the present disclosure is not limited thereto.

According to an embodiment of the present disclosure, the porous fiber film may only include the hollow nanofibers.

In an embodiment of the present disclosure, the hollow nanofibers may, for example, be formed by electrospinning.

In an embodiment of the present disclosure, the diameter of the hollow nanofiber may be changed by the viscosity and boiling point of the polymer solution for manufacturing the porous fiber film, the magnitude of voltage applied to the electrospinning machine, the pump speed, the nozzle radius, the distance between the electrospinning substrate and the nozzle, or the rotational speed of the substrate, and may, for example, be 50 nm to 3 μm. Specifically, the diameter of the hollow nanofiber may be 100 nm to 1 μm, 100 nm to 500 nm, 100 nm to 300 nm, or 150 nm to 200 nm, but the present disclosure is not limited thereto. The diameter of the hollow nanofiber may, for example, be a measured value through scanning electron microscopy (SEM) observation of the porous fiber film. The SEM observation for diameter measurement of the hollow nanofibers may, for example, be done through 10 kV energy beam using Philips XL30S, but the SEM observation method is not limited thereto.

In an embodiment of the present disclosure, the diameter of the void inside the hollow nanofiber may, for example, be 10 nm to 1 μm. Specifically, the diameter of the void inside the hollow nanofiber may be 20 nm to 500 nm, 30 nm to 200 nm, 40 nm and 100 nm, or 50 nm and 80 nm, but the present disclosure is not limited thereto. The diameter of the void inside the hollow nanofiber may, for example, be a measured value through Focused Ion Beam-Scanning Electron Microscopy (FIB-SEM) observation of a cross section of the porous fiber film. The FIB-SEM observation for diameter measurement of the hollow nanofibers may, for example, be done using Thermofisher Helios G4 FX ion beam and Philips XL30S SEM machine, but the SEM observation method is not limited thereto.

In an embodiment of the present disclosure, the thickness of the porous fiber film may be subject to change depending on the size of the negative electrode or the thickness of the lithium metal layer, and may, for example, be 100 nm to 100 μm. Specifically, the thickness of the porous fiber film may be 1 μm to 80 μm, 10 μm to 50 μm, 10 μm to 20 μm or 15 μm to 20 μm, but the present disclosure is not limited thereto. The thickness of the porous fiber film may, for example be a measured value through SEM observation of the porous fiber film. The SEM observation for thickness measurement of the porous fiber film may, for example, be done through 10 kV energy beam using Philips XL30S, but the SEM observation method is not limited thereto.

In an embodiment of the present disclosure, the main polymer and the carrier polymer may, for example, be included at a weight ratio of 10:1 to 1:10, and specifically, may be included at the weight ratio of 5:1 to 1:5, 3:1 to 1:3, 2:1 to 1:2, or 2:1 to 1:1, but the present disclosure is not limited thereto. When the weight ratio of the main polymer to the carrier polymer in the porous fiber film falls within the aforementioned range, it may have a beneficial effect on the transport of lithium ions by the main polymer, the porosity control by the carrier polymer and the consequential increased life of the lithium secondary battery, but the present disclosure is not limited thereto.

In an embodiment of the present disclosure, the negative electrode including the lithium metal layer and the porous fiber film may be (1) a current collector-free type including the lithium metal layer and the porous fiber film without including the current collector, (2) a type including the negative electrode current collector and the lithium metal layer/the porous fiber film present on at least one surface of the negative electrode current collector in a sequential order, or (3) a type (anode-free type) including the negative electrode current collector and the porous fiber film at the time of manufacturing the battery, without including the lithium metal layer that will be formed between the negative electrode current collector and the porous fiber film due to reduction reactions of lithium ions supplied from the positive electrode and the electrolyte during the initial charging of the battery, and the present disclosure is not limited thereto.

In an embodiment of the present disclosure, when the negative electrode is (3) an anode-free type including the negative electrode collector and the porous fiber film at the time of manufacturing the electrode, the porous fiber film may be placed on at least one surface of the negative electrode current collector and assembled into the battery, or the porous fiber film may be placed on at least one surface of the separator, and the current collector and the separator may be joined such that the current collector contacts the porous fiber film and assembled into the battery, and the present disclosure is not limited thereto.

In an embodiment of the present disclosure, the negative electrode may include the negative electrode current collector and the lithium metal layer present on one or two surfaces of the negative electrode current collector. Alternatively, the negative electrode may include a free-standing lithium metal plate and the porous fiber film without the current collector.

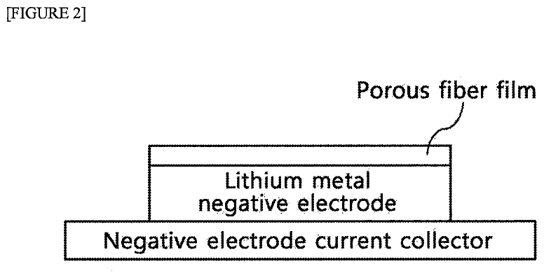

FIG. 2 is a diagram of the negative electrode according to an embodiment of the present disclosure. The negative electrode includes the current collector, the lithium metal layer present on one surface of the current collector and the porous fiber film present on one surface of the lithium metal layer.

In an embodiment of the present disclosure, when the negative electrode includes the current collector, the current collector is not limited to a particular one and may include those that support the lithium metal layer and have high conductivity without causing chemical changes in the lithium secondary battery using the same. For example, the current collector may include, for example, copper, stainless steel, aluminum, nickel, titanium, palladium, calcined carbon, copper or stainless steel treated with carbon, nickel or silver on the surface, aluminum-cadmium alloys.

In an embodiment of the present disclosure, the current collector may include a copper foil, and may, for example, have a thickness of 1 μm to 600 μm, 3 μm to 500 μm, 10 μm to 600 μm, 10 μm to 200 μm, 10 μm to 100 μm, 10 μm to 50 μm, 10 μm to 30 μm, 10 μm to 20 μm, or 10 μm to 15 μm, but the present disclosure is not limited thereto.

In an embodiment of the present disclosure, the lithium metal layer may include a lithium metal thin film or a lithium metal powder. In this instance, the lithium metal may include a lithium metal alone, or a lithium alloy containing lithium.

In an embodiment of the present disclosure, the lithium metal layer may include a lithium metal, a lithium alloy or a mixture thereof.

In an embodiment of the present disclosure, the lithium alloy may include, for example, an alloy of lithium (Li) and metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), zinc (Zn), indium (In), silver (Ag) and tin (Sn), but the present disclosure is not limited thereto.

In an embodiment of the present disclosure, the lithium metal layer may be a thin-film layer including lithium metal (Li) alone.

In an embodiment of the present disclosure, a thickness of the lithium metal layer may, for example, be 600 μm or less. Additionally, the thickness of the lithium metal layer may, for example, be 50 nm or more. Specifically, the thickness of the lithium metal layer may be 50 nm to 600 μm, 1 μm to 500 μm, 5 μm to 300 μm, 10 μm to 200 μm, 10 μm to 100 μm, 20 μm to 80 μm, 20 μm to 70 μm, 20 μm to 60 μm, 20 μm to 55 μm, 25 μm to 55 μm, 25 μm to 50 μm, 25 μm to 45 μm, 30 μm to 45 μm, 25 μm to 40 μm, 25 μm to 35 μm, or 30 μm. When the thickness of the lithium metal layer falls within the aforementioned range, it may have a beneficial effect on the packing density of the battery and the energy density of the battery, but the present disclosure is not limited thereto.

In addition, the negative electrode according to an embodiment of the present disclosure may further include any component commonly used in the negative electrode of the lithium secondary battery, in particular, the lithium metal battery, and such component is not limited to a particular one without departing from the scope of the present disclosure.

### Lithium Secondary Battery

According to another aspect of the present disclosure, provided is a lithium secondary battery including the above-described negative electrode.

In an embodiment of the present disclosure, the lithium secondary battery may be, to be specific, a lithium metal battery.

The lithium secondary battery according to an aspect of the present disclosure includes the-described negative electrode, a positive electrode, an electrolyte and a battery case.

In an embodiment of the present disclosure, the electrolyte is not limited to a particular type and may include any type of electrolyte for use in the lithium secondary battery.

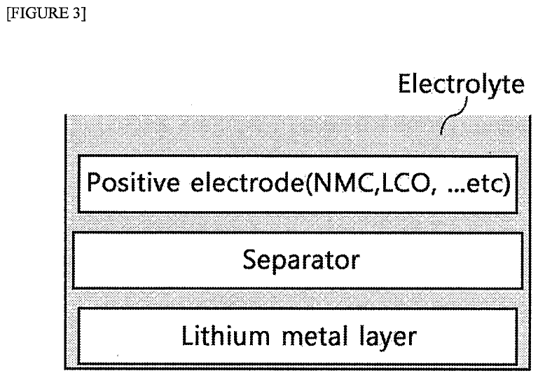

FIG. 3 is a cross-sectional view of the lithium secondary battery in which the electrolyte is in a liquid state as an embodiment of the present disclosure. Referring to FIG. 3, when the electrolyte is in a liquid state, the lithium secondary battery includes a separator positioned between the positive electrode and the negative electrode (the lithium metal layer), and the positive electrode, the separator and the negative electrode may be immersed in the electrolyte. In this instance, the above-described porous fiber film may be preferably positioned between the lithium metal layer and the separator.

In an embodiment of the present disclosure, when the electrolyte is in a liquid state, an insulating film may be further included between the positive electrode and the negative electrode to prevent a short circuit in the battery due to physical contact between the positive electrode and the negative electrode. The insulating film may physically insulate the positive electrode from the negative electrode to prevent a short, and provide movement pathways of lithium ions between the positive electrode and the negative electrode. The insulating film may be a stand-alone element such as a film, or a coating layer added to the positive electrode and/or the negative electrode.

In an embodiment of the present disclosure, the insulating film is not limited to a particular one and may include those that separate or insulate the positive electrode from the negative electrode and allow for lithium ion migration between the positive electrode and the negative electrode, and may include those commonly used as the insulating film or the separator in the lithium-sulfur battery. For example, the insulating film may be made of a porous non-conductive or insulating material.

In an embodiment of the present disclosure, the insulating film may come in many different structures known in the art. For example, the insulating film may have a porous substrate structure such as a film, a sheet, a mesh, a net, a porous body, a foam or a non-woven fabric. These structures may be used alone or in combination.

In an embodiment of the present disclosure, the insulating film may include a porous substrate, and the porous substrate may include any porous substrate commonly used in the secondary battery, and may include a porous polymer film alone or in stack, for example, a non-woven fabric or a polyolefin-based porous film made of high-melting-point glass fibers or polyethylene terephthalate fibers, but is not limited thereto. In an embodiment of the present disclosure, a porosity of the insulating film may, for example, be 10 to 95 vol %, 40 to 70 vol %, or 41 to 45 vol %, but the present disclosure is not limited thereto.

In an embodiment of the present disclosure, when the electrolyte is provided in a liquid state, the electrolyte may include, for example, a lithium salt and a non-aqueous solvent.

In an embodiment of the present disclosure, the lithium salt may include, for example, LiPF₆, LiBF₄, LiSbF₆, LiAsF₆, LiN(SO₃C₂F₅)₂, LiC₄F₉SO₃, LiClO₄, LiAlO₂, LiAlCl₄, LiCl, LiI, LiB(C₂O₄)₂ (LiBOB), LiBF₂(C₂O₄) (LiDFOB), LiSCN, LiBr, Li₂SO₄, Li₂B₁₀Cl₁₀, LiCF₃SO₃, LiN(SO₂F)₂ (LiFSI), LiN(CF₃SO₂)₂ (LiTFSI), LiN(C₂F₅SO₂)₂, LiC(CF₃SO₂)₃, NaClO₄, NaI, NaSCN, NaBr, KClO₄, KSCN, stearyl sulfonic acid lithium, octyl sulfonic acid lithium or a mixture thereof, but the present disclosure is not limited thereto.

In an embodiment of the present disclosure, the non-aqueous solvent is not limited to a particular type and may include any type of non-aqueous solvent used in the lithium secondary battery, and may include, for example, linear carbonates, cyclic carbonates, ethers, esters, amides, ketones, their derivatives, or a mixture thereof. The non-aqueous solvent may include, for example, ethylene carbonate (EC), propylene carbonate (PC), butylene carbonate, pentylene carbonate, vinylene carbonate, vinylethylene carbonate, chloroethylene carbonate, dimethyl carbonate (DMC), diethyl carbonate (DEC), dipropyl carbonate, ethyl methyl carbonate (EMC), methylpropyl carbonate, ethylpropyl carbonate, methyl propionate, ethyl propionate, propyl propionate, dimethyl ether, diethyl ether, dipropyl ether, methyl ethyl ether, methyl propyl ether, ethylpropyl ether, tetrahydrofuran, methyltetrahydrofuran, dioxane, dimethoxyethane, dibutoxyethane, dibutyl ether, diglyme, methyl diglyme, tetraglyme, methyl formate, methyl acetate, ethyl acetate, propyl acetate, methyl butyrate, methyl propionate, ethyl propionate, gamma butyrolactone, valerolactone, mevalonolactone, caprolactone, cyclohexanone, acetonitrile, benzonitrile, dioxolane, ethylene sulfide, sulfolane, their derivatives, or a mixture thereof, but the present disclosure is not limited thereto. In an embodiment of the present disclosure, the liquid-state electrolyte may further include at least one type of additive of esters such as vinylene carbonate, fluoroethylene carbonate, vinyl ethylene sulfite, vinyl ethylene carbonate, succinic anhydride, glutamic anhydride, propanesultone, acid anhydrides and electrolytes at an optimal ratio, but the present disclosure is not limited thereto.

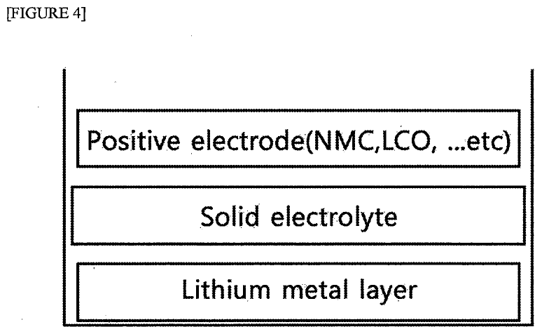

FIG. 4 is a cross-sectional view of the lithium secondary battery in which the electrolyte is in a solid state as an embodiment of the present disclosure. Referring to FIG. 4, when the electrolyte is in a solid state, the lithium secondary battery may include a solid electrolyte membrane positioned between the positive electrode and the negative electrode (the lithium metal layer). In this instance, the above-described porous fiber film may be preferably positioned between the lithium metal layer and the solid electrolyte membrane.

In an embodiment of the present disclosure, when the electrolyte is provided in a solid state, the electrolyte may be provided in the form of the solid electrolyte membrane including a solid electrolyte and a binder polymer to bind the solid electrolyte, and may act as an insulating film to prevents a short circuit between the positive electrode and the negative electrode.

In an embodiment of the present disclosure, when the electrolyte is provided in a solid state, the solid-state electrolyte may include, for example, organic/inorganic solid materials such as sulfides, oxides, dry polymers or gel polymers, but the present disclosure is not limited thereto. The solid-state electrolyte may include, for example, Li₁₀GeP₂S₁₂ (LGPS), Li_{9.54}Si_{1.74}P_{1.44}S_{11.7}Cl_{0.3} (LSPSCl), argyrodite, LPS, LPS/LiCl mixture, perovskites (LLTO), NASICON, LISICON, garnet-type (LLZO), LAGP, LATP, PEO-based electrolytes or a mixture thereof, but the present disclosure is not limited thereto.

In an embodiment of the present disclosure, the positive electrode of the lithium secondary battery may include the commonly used active material, and is not limited to a particular type and/or shape.

In an embodiment of the present disclosure, the positive electrode may include a positive electrode current collector and a positive electrode active material layer coated on one or two surfaces of the positive electrode current collector.

The positive electrode current collector is not limited to a particular one and may include those that support the positive electrode active material and have high conductivity without causing chemical changes in the corresponding battery. For example, the positive electrode current collector may include copper, stainless steel, aluminum, nickel, titanium, palladium, calcined carbon, copper or stainless steel treated with carbon, nickel or silver on the surface, or aluminum-cadmium alloys.

The positive electrode current collector may have a microtextured surface to increase the bond strength with the positive electrode active material, and may come in many different forms such as a film, a sheet, a foil, a mesh, a net, a porous body, a foam or a non-woven body.

The positive electrode active material layer includes the positive electrode active material and may further include a conductive material, a binder and an additive.

In an embodiment of the present disclosure, the positive electrode may include, as the active material, at least one selected from transition metal elements, Group IIIA elements, Group IVA elements, their sulfur compounds and their alloys with sulfur. The transition metal elements may include Sc, Ti, V, Cr, Mn, Fe, Co, Ni, Cu, Zn, Y, Zr, Nb, Mo, Tc, Ru, Rh, Pd, Os, Ir, Pt, Au or Hg, and the Group IIIA elements may include Al, Ga, In or Ti, and the Group IVA elements may include Ge, Sn or Pb.

In an embodiment of the present disclosure, the positive electrode may include, as the active material, for example, lithium transition metal oxide; lithium metal iron phosphate; lithium nickel-manganese-cobalt oxide; transition metal-substituted lithium nickel-manganese-cobalt oxide; or two or more thereof, but is not limited thereto. Specifically, the positive electrode active material may include, for example, layered compounds such as lithium cobalt oxide (LiCoO₂) or lithium nickel oxide (LiNiO₂), or compounds with one or more transition metal substitution; lithium manganese oxide such as chemical formula Li₁₊ₓMn₂₋ₓO₄ (x is 0~0.33), LiMnO₃, LiMn₂O₃ or LiMnO₂; lithium copper oxide (Li₂CuO₂); vanadium oxide such as LiV₃O₈, LiV₃O₄, V₂O₅ or Cu₂V₂O₇; Ni-site type lithium nickel oxide represented by chemical formula LiNi₁₋ₓMₓO₂ (M=Co, Mn, Al, Cu, Fe, Mg, B or Ga and x=0.01~0.3); lithium manganese composite oxide represented by chemical formula LiMn₂₋ₓMₓO₂ (M=Co, Ni, Fe, Cr, Zn or Ta and x=0.01~0.1) or Li₂Mn₃MO₈ (M=Fe, Co, Ni, Cu or Zn); lithium metal phosphate LiMPO₄ (M=Fe, CO, Ni or Mn); lithium nickel-manganese-cobalt oxide Li₁₊ₓ(NiₐCo_{b}Mn_{c})₁₋ₓO₂ (x=0~0.03, a=0.3~0.95, b=0.01~0.35, c=0.01~0.5, a+b+c=1); aluminum-substituted lithium nickel-manganese-cobalt oxide Liₐ[Ni_{b}Co_{c}Mn_{d}Alₑ]_{1-f}M1_{f}O₂ (M1 is at least one selected from the group consisting of Zr, B, W, Mg, Ce, Hf, Ta, La, Ti, Sr, Ba, F, P and S, and 0.8≤a≤1.2, 0.5≤b≤0.99, 0<c<0.5, 0<d<0.5, 0.01≤e≤0.1, 0≤f<0.1); transition metal-substituted lithium nickel-manganese-cobalt oxide Li₁₊ₓ(NiₐCo_{b}Mn_{c}M_{d})₁₋ₓO₂ (x=0~0.03, a=0.3~0.95, b=0.01~0.35, c=0.01~0.5, d=0.001~0.03, a+b+c+d=1, M is any one selected from the group consisting of Fe, V, Cr, Ti, W, Ta, Mg and Mo), disulfide compounds; or Fe₂(MoO₄)₃, but is not limited thereto.

In an embodiment of the present disclosure, in addition to the positive electrode active material, the positive electrode active material layer may further include the conductive material, the binder and/or the additive. The conductive material, the binder and the additive may include those commonly used in the lithium secondary battery, and its detailed description is omitted.

In an embodiment of the present disclosure, the lithium secondary battery may have various shapes, and the battery case may have a coin shape, a pouch shape, a prismatic shape or a cylindrical shape as commonly used, but the present disclosure is not limited thereto.

As described above, when the negative electrode according to an embodiment of the present disclosure is applied to the lithium secondary battery, the porous fiber film of the negative electrode may act as a protective layer to physically prevent the growth of lithium dendrites and improve the mechanical strength of the negative electrode, thereby improving the cycle life of the battery, but the effects of the present disclosure are not limited thereto.

In particular, according to an embodiment of the present disclosure, the lithium metal battery with improved charge/discharge cycle life may be provided.

Hereinafter, examples are presented to help the understanding of the present disclosure, but the following examples are provided to describe the present disclosure for illustrative purposes, and it is obvious to those skilled in the art that various changes and modifications may be made within the scope and technical aspects of the present disclosure, and it is apparent that such changes and modifications fall within the scope of the appended claims.

### Preparation of Lithium Metal Battery

### Example 1

### Preparation of Porous Fiber Film

First, a free-standing porous fiber film was manufactured by electrospinning as follows.

A collector plate was placed within an electrospinning chamber, and the internal temperature of the chamber was maintained at 25 °C. Subsequently, carboxymethyl guar gum (CMGG) and polyacrylamide (PAM) were completely dissolved in a deionized water (DI) solvent at a weight ratio of 1:1 to prepare a carboxymethyl guar gum solution and a polyacrylamide solution (30 wt %). The prepared mixed polymer solution was put into a 10 mL syringe equipped with a 21-gauge metal needle and fixed to a syringe pump, and the collector plate was connected to a cable to maintain a high voltage of 15 kV, and mounted with a gap of 10 cm between the collector plate and the needle. Electrospinning was performed at a spinning speed of 15 μL/min to obtain a 20 μm-thick porous fiber film. As a result of measuring the porosity of the porous fiber film using a porosimeter (MIP, PM33GT, Quantachrome), the porosity was 95 vol %.

### Preparation of Negative Electrode

A 200 μm-thick lithium metal plate laminated on a copper foil (15 μm) was prepared, and the as-prepared porous fiber film was laminated on one surface of the lithium metal plate and punched into a size of 16φ to prepare a negative electrode.

### Preparation of Positive Electrode

A slurry containing 94% of NMC622 positive electrode active material (LiNi_{0.6}Mn_{0.2}Co_{0.2}O₂), 3% of a conductive material and 3% of a binder on the weight basis was applied to an aluminum foil and dried to form a positive electrode active material layer, and punched into a size of 12φ to prepare a positive electrode.

### Preparation of 2032 Coin-Type Battery

A polypropylene (PP) separator having a thickness of 25 μm and a porosity of 46 vol % as well as a size of 19φ after punching was placed between the as-prepared positive electrode and the as-prepared negative electrode.

The positive electrode/separator/negative electrode assembly was placed in a coin-type case within a glove box under an argon environment, an electrolyte containing 1 M LiPF₆ dissolved in a non-aqueous solvent of ethylene carbonate/diethyl carbonate (EC/DEC 3:7 v/v) was injected, and the case was sealed with a lid to manufacture a coin-type battery.

### Example 2

A lithium metal battery was manufactured by the same method as Example 1, except that carboxymethyl guar gum and polyacrylamide were used at a weight ratio of 1:3 when manufacturing the porous fiber film.

### Example 3

A lithium metal battery was manufactured by the same method as Example 1, except that carboxymethyl guar gum and polyacrylamide was used at a weight ratio of 3:1 when manufacturing the porous fiber film.

### Comparative Example 1

A lithium metal battery was manufactured by the same method as Example 1, except that a lithium metal plate was used as the negative electrode without laminating the porous fiber film.

### Comparative Example 2

A lithium metal battery was manufactured by the same method as Example 1, except that when manufacturing the porous fiber film, carboxymethyl guar gum was not used and only polyacrylamide was used, and in this instance, the total polymer concentration was equal. As a result of measuring the porosity of the obtained porous fiber film using a porosimeter (MIP, PM33GT, Quantachrome), the porosity was 95 vol %.

### Morphological Analysis of Porous Fiber Film

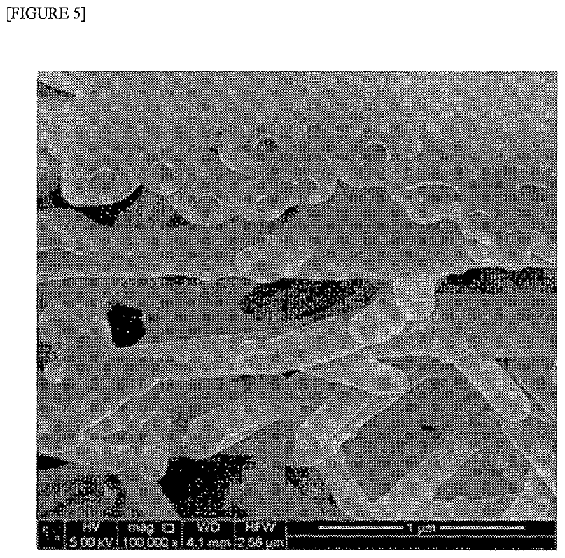

A cross-sectional SEM image of the porous fiber film of Example 1 observed using FIB-SEM (Thermofisher, Helios G4 FX ion beam; and Philips, XL30S SEM, 5.00 kV, 100,000× magnification) is shown in FIG. 5.

As can be seen from FIG. 5, it was confirmed that the porous fiber film was made of nanofibers, and the nanofibers were hollow. In this instance, the measured diameters of the nanofibers were distributed in a range of 150 nm to 200 nm, and the void size was 80 nm.

### Performance Evaluation of Lithium Metal Battery

### Experimental Example 1. Performance Evaluation of Lithium Metal Symmetric Battery

A 2032 coin-type lithium metal symmetric battery was manufactured by the same method as the above-described method using a pair of negative electrodes instead of the positive electrode manufactured above, and electrochemical performance was evaluated using a cycle tester (WBCS3000, Wonatech) at the temperature of 25 °C.

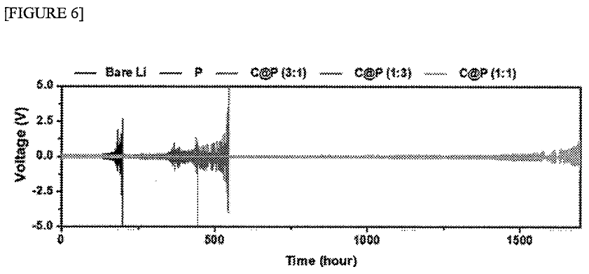

Each of the lithium metal symmetric batteries using the negative electrodes of Examples 1 to 3 and Comparative Examples 1 and 2 was charged and discharged for 1 hour at the current density of 1 mA cm⁻². In this instance, FIG. 6 shows a voltage measurement graph over time, and TABLE 1 below summarizes the cycle number at which overvoltage of 1 V or more occurred.

TABLE 1

| | Composition of | Cycle number (1 V |
|---|---|---|
| Classification | porous fiber film | overvoltage basis) |
| Example 1 | C@P 1:1 | 840 |
| Example 2 | C@P 1:3 | 220 |
| Example 3 | C@P 3:1 | 250 |
| Comparative Example 1 | - (Bare Li) | 90 |
| Comparative Example 2 | P | 184 |

As shown in FIG. 6 and the results in TABLE 1, compared to the negative electrode without the porous fiber film (Comparative Example 1) or with the porous fiber film made of polyacrylamide alone (Comparative Example 2), it was confirmed that the use of the negative electrode having the porous fiber film according to an embodiment of the present disclosure dramatically improves the life of the battery.

### Experimental Example 2. Performance Evaluation of Lithium Metal Battery

For each of the lithium metal batteries of Examples 1 to 3 and Comparative Examples 1 and 2, a charge-discharge test was conducted as follows.

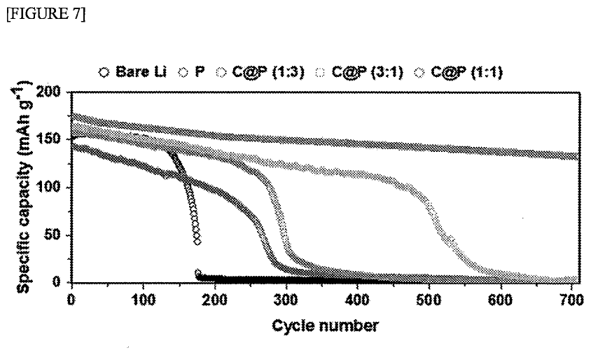

In the first cycle, the charge-discharge test was conducted by charging the battery at 0.1 C constant current until the voltage reached 4.2 V, and discharging at 0.1 C constant current until the voltage reached 2.8 V. Subsequently, the charge-discharge test was conducted by charging the lithium metal battery at 1 C constant current until the voltage reached 4.2 V and discharging at 1 C constant current until the voltage reached 2.8 V. A cycle-specific capacity graph obtained as a result of the charge-discharge test is shown in FIG. 7, and TABLE 2 below summarizes the cycle number at which the specific capacity reached 80% relative to initial specific capacity.

TABLE 2

| | Composition of | Cycle number |
|---|---|---|
| | porous fiber film | (retention 80% basis) |
| Example 1 | C@P 1:1 | 536 |
| Example 2 | C@P 1:3 | 228 |
| Example 3 | C@P 3:1 | 243 |
| Comparative Example 1 | - (Bare Li) | 150 |
| Comparative Example 2 | P | 126 |

As shown in FIG. 7 and the results in TABLE 2, it was confirmed that the cycle number of the lithium metal batteries of Examples 1 to 3 was greatly improved compared to the batteries of Comparative Examples 1 and 2, showing that the porous fiber film suppresses the formation of lithium metal dendrites and dead lithium.

### Experimental Example 3. Elemental Analysis of Solid Electrolyte Interface (SEI) after Charging and Discharging

To evaluate the composition of the SEI layer on the lithium surface, the lithium metal symmetric batteries manufactured using the negative electrodes of Example 1 and Comparative Examples 1 and 2 in Experimental Example 1 were disassembled after cycling.

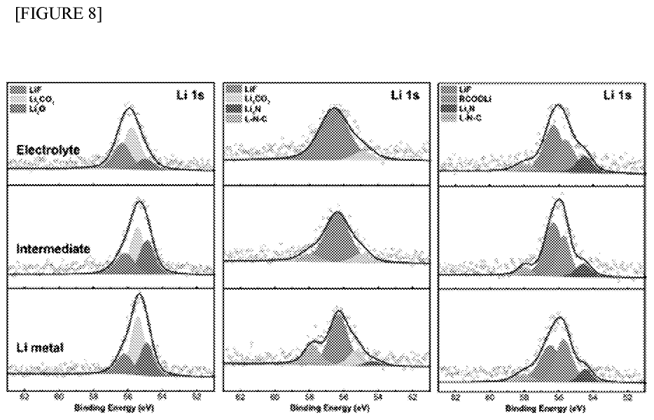

After the charge-discharge test for 50 cycles, the composition of the SEI layer and the porous fiber film was analyzed using Depth-XPS (Axis-Supra, Kratos) for each of three layers: lithium interface; middle layer; electrolyte interface, and the analysis results are shown in FIG. 8. FIG. 8 shows the results of Comparative Example 1, Comparative Example 2 and Example 1 in that order from the left side. Additionally, the Li Is spectra of FIG. 8 shows LiF at 56.4 eV, Li₂O at 54.9 eV, Li₂CO₃ at 55.2 eV, and RCOOLi at 55.6 eV.

In this instance, TABLE 3 below summarizes the amount (percent) of each element within the SEI layer.

TABLE 3

| Classification | Li₂O | Li₂CO₃ | LiF | Li₃N |
|---|---|---|---|---|
| Example 1 | — | — | 47.3% | 11.3% |
| Comparative Example 1 | 25% | 49% | 26% | — |
| Comparative Example 2 | — | 13% | 75.6% | 2% |

It was confirmed that compared to the composition of the SEI layer of Comparative examples 1 and 2, the SEI layer of Example 1 includes the materials having high ionic conductivity and electrochemical stability in much larger amounts, showing fast lithium ion migration at the negative electrode having the porous fiber film according to an embodiment of the present disclosure.

### Experimental Example 4. Surface Observation of Porous Fiber Film after Charging and Discharging

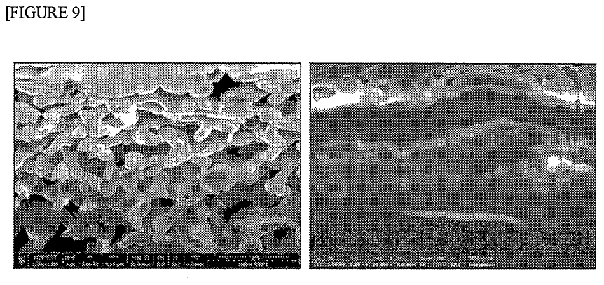

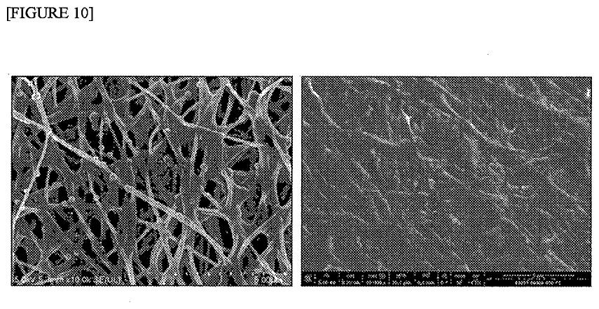

After the charge-discharge test for 50 cycles, the lithium metal symmetric batteries manufactured using the negative electrodes of Example 1 and Comparative Example 2 in Experimental Example 1 were disassembled to observe the porous fiber film, and FIGS. 9 and 10 show the observation results.

FIG. 9 shows an FIB-SEM cross-sectional image of the porous fiber film (left: Example 1, right: Comparative Example 2), and FIG. 10 shows an SEM surface image of the porous fiber film (left: Example 1, right: Comparative Example 2).

Referring to FIG. 9, it was confirmed that the porous fiber film of Example 1 plays a role in suppressing the dendrite growth due to the hollow nanofibers that confine lithium dendrites, whereas the porous fiber film of Comparative Example 2 was completely filled with lithium dendrites and by-products, and it is not a porous structure any longer.

Referring to FIG. 10, as a result of surface observation of the porous fiber film of Example 1, it was confirmed that the fiber structures were completely maintained and bead-shaped lithium dendrites attached to the surface of some fibers were found. In contrast, as a result of surface observation of the porous fiber film of Comparative Example 2, it was confirmed that lithium dendrites and by-products were filled in between the fibers, and no fiber structure was found. Through this, it was confirmed that the pores of the porous fiber film according to Comparative Example 2 were blocked after a few tens of cycles, hindering the movement of lithium ions.

What is claimed is:

1. A negative electrode for a lithium secondary battery, comprising:
a lithium metal layer; and
a porous fiber film that contacts at least one surface of the lithium metal layer,
wherein the porous fiber film comprises a main polymer and a carrier polymer,
wherein the main polymer contains at least one anionic functional group, and
wherein the carrier polymer contains a functional group that forms a hydrogen bond with the anionic functional group of the main polymer.

2. The negative electrode for the lithium secondary battery according to claim 1,
wherein the porous fiber film is manufactured by electrospinning.

3. The negative electrode for the lithium secondary battery according to claim 1,
wherein the porous fiber film includes hollow nanofibers.

4. The negative electrode for the lithium secondary battery according to claim 3,
wherein a diameter of the hollow nanofiber is 50 nm to 3 μm.

5. The negative electrode for the lithium secondary battery according to claim 3,
wherein a diameter of a void inside the hollow nanofiber is 10 nm to 1 μm.

6. The negative electrode for the lithium secondary battery according to claim 1,
wherein a thickness of the porous fiber film is 100 nm to 100 μm.

7. The negative electrode for the lithium secondary battery according to claim 1,
wherein the anionic functional group includes a carboxylate group, a sulfonate group, a sulfate group, a phosphate group, a phosphonate group, an imide-based anionic group, a phenolate group, or two or more thereof.

8. The negative electrode for the lithium secondary battery according to claim 1,
wherein the main polymer includes guar gum, carboxymethyl guar gum, cellulose acetate, a copolymer of two or more monomers thereof, or a mixture thereof.

9. The negative electrode for the lithium secondary battery according to claim 1,
wherein the carrier polymer includes polyvinylidene fluoride, poly(vinylidene fluoride-co-hexafluoropropylene), perfluoropolymer, polyvinyl alcohol, polyvinyl chloride, polyvinylidene chloride, polyethylene oxide, polyethylene glycol dialkyl ether, polyethylene glycol dialkyl ester, poly(oxymethylene-oligo-oxyethylene), polypropylene oxide, polyvinylacetate, poly(vinylpyrrolidone-vinylacetate), polystyrene, polyacrylonitrile, polyacrylamide, polymethyl methacrylate, polyamide, polyimide, poly(meta-phenylene isophthalamide), polysulfone, polyether ketone, polyetherimide, polyethylene terephthalate, polyethylene naphthalate, polyester, poly(1,1,2,2-tetrafluoroethylene), polyphosphazene, polyurethane, a copolymer of two or more monomers thereof, or a mixture thereof.

10. The negative electrode for the lithium secondary battery according to claim 1,
wherein the carrier polymer contains an amide group.

11. The negative electrode for the lithium secondary battery according to claim 1,
wherein the main polymer includes carboxymethyl guar gum, and
wherein the carrier polymer includes polyacrylamide.

12. The negative electrode for the lithium secondary battery according to claim 1,
wherein a weight ratio of the main polymer to the carrier polymer is 5:1 to 1:5.

13. The negative electrode for the lithium secondary battery according to claim 1,
wherein a weight ratio of the main polymer to the carrier polymer is 2:1 to 1:2.

14. The negative electrode for the lithium secondary battery according to claim 1,
wherein a thickness of the lithium metal layer is 50 nm to 600 μm.

15. A lithium secondary battery comprising the negative electrode according to claim 1, a positive electrode, an electrolyte and a battery case.
